(19) United States
(12) Patent Application Publication
(10) Pub. No.: US 2011/0264477 A1
(43) Pub. Date: Oct. 27, 2011

(54) METHODS AND A SYSTEM FOR USE OF BUSINESS PROCESS MANAGEMENT FOR DEMAND RESPONSE

(75) Inventors: Hubert Delany, New Rochelle, NY (US); John A. Johnson, Belle Harbor, NY (US)

(73) Assignee: CALM Energy, Inc., Belle Harbor, NY (US)

(21) Appl. No.: 13/015,478

(22) Filed: Jan. 27, 2011

Related U.S. Application Data
(60) Provisional application No. 61/298,885, filed on Jan. 27, 2010.

(51) Int. Cl. G06Q 10/00

(52) U.S. Cl. 705/7.11

(57) ABSTRACT

In one embodiment, a method for managing a demand response process which includes at least steps of: providing an interface having a plurality of programmable elements, wherein each programmable element can be associated with a particular action to be performed during the demand response process when a particular programmable element is programmed and incorporated into at least one business process modeling diagram associated with the at least one demand response process, and wherein the demand response process is initiated in response to at least one trigger condition of at least one first enterprise process; monitoring the at least one first enterprise process for a presence of the at least one trigger condition; and executing, by a computer system, the demand response process in accordance with the at least one business process modeling diagram when the at least one trigger condition is present.

### RELATED APPLICATIONS

This application claims the benefit of U.S. provisional application Ser. No. 61/298,885 filed Jan. 27, 2010, and entitled “METHODS AND A SYSTEM FOR USE OF BUSINESS PROCESS MANAGEMENT FOR DEMAND RESPONSE,” which is hereby incorporated by reference herein in the entirety for all purposes.

### TECHNICAL FIELD

The present invention relates to demand response management.

### BACKGROUND

In one embodiment, the instant invention is related to a technical approach to manage demand response system for energy supply through a power grid. For example, a power grid may include one or all of the following: electricity generation, electric power transmission, and electricity distribution. Electricity may be generated using generating stations, such as a coal fire power plant, a nuclear power plant, etc. For efficiency purposes, the generated electrical power is stepped up to a very high voltage (such as 345K Volts) and transmitted over transmission lines. The transmission lines may transmit the power long distances, such as across state lines or across international boundaries, until it reaches its wholesale customer, which may be a company that owns the local distribution network. The transmission lines may terminate at a transmission substation, which may step down the very high voltage to an intermediate voltage (such as 138K Volts). From a transmission substation, smaller transmission lines (such as sub-transmission lines) transmit the intermediate voltage to distribution substations. At the distribution substations, the intermediate voltage may be again stepped down to a “medium voltage” (such as from 11K Volts to 33K Volts). One or more feeder circuits may emanate from the distribution substations. For example, four to tens of feeder circuits may emanate from the distribution substation. The feeder circuit is a 3-phase circuit comprising 4 wires (three wires for each of the 3 phases and one wire for neutral). Feeder circuits may be routed either above ground (on poles) or underground. The voltage on the feeder circuits may be tapped off periodically using distribution transformers, which step down the voltage from “medium voltage” to the consumer voltage (such as 120V). The consumer voltage may then be used by the consumer.

In another embodiment, the instant invention is related to a technical approach to manage demand response system for energy supply through out a building, facility or an aggregation of many buildings under one coordinated management (e.g. college campus). In a building, energy supply may include electricity, HVAC, gas, electric storage (e.g. Electric Vehicles, Lithium-Ion Batteries), diesel storage, steam, compressed gases (e.g. Air compressed as a motive force for equipment), other petroleum devices, solar energy in the converted form of heat or electricity, wind energy in the converted form or electricity.

### SUMMARY OF INVENTION

In some embodiments, the instant invention involves a method for managing at least one demand response process which includes at least the steps of: providing, by a computer system, an interface having a plurality of programmable elements, wherein each programmable element can be associated with a particular action to be performed during the at least one demand response process when a particular programmable element is programmed and incorporated into at least one business process modeling diagram associated with the at least one demand response process, and wherein the at least one demand response process is initiated in response to at least one trigger condition of at least one first enterprise process; receiving, by a computer system, first design data corresponding to the at least one business process modeling diagram; monitoring, by a computer system, the at least one first enterprise process for a presence of the at least one trigger condition by performing at least one of the following: i) receiving process data associated with the at least one first enterprise process, and ii) subjecting at least one process element of the at least one first enterprise process to at least one: a) normal operating condition, and b) abnormal operating condition; and executing, by a computer system, the at least one demand response process in accordance with the at least one business process modeling diagram when the at least one trigger condition is present.

In some embodiments, the instant invention involves a method that includes a step of receiving second design data wherein the second design data corresponds to at least one change in the at least one business process modeling diagram.

In some embodiments, the instant invention involves a method that includes at least one change that is based on process data of at least one second enterprise process.

In some embodiments, the instant invention involves a method that includes a step of generating at least one notification based on at least one rule.

In some embodiments, the instant invention involves a method that includes at least one rule is associated with the presence of at least one trigger condition.

In some embodiments, the instant invention involves a computer system for managing at least one demand response process which includes a) memory having at least one region for storing computer executable program code; and b) a processor for executing the program code stored in the memory, wherein the program code that includes: i) code to provide an interface having a plurality of programmable elements, wherein each programmable element can be associated with a particular action to be performed during the at least one demand response process when a particular programmable element is programmed and incorporated into at least one business process modeling diagram associated with the at least one demand response process, and wherein the at least one demand response process is initiated in response to at least one trigger condition of at least one first enterprise process; ii) code to receive first design data corresponding to the at least one business process modeling diagram; iii) code to monitor the at least one first enterprise process for a presence of the at least one trigger condition by performing at least one of the following: 1) receiving process data associated with the at least one first enterprise process, and 2) subjecting at least one process element of the at least one first enterprise process to at least one: A) normal operating condition, and B) abnormal operating condition; and iv) code to execute the at least one demand response process in accordance with the at least one business process modeling diagram when the at least one trigger condition is present.

### BRIEF DESCRIPTION OF THE DRAWINGS

FIG. 1 shows a schematic diagram of an embodiment of the present invention.

FIG. 2 shows a schematic diagram of another embodiment of the present invention.

FIG. 3 shows a schematic diagram of yet another embodiment of the present invention.

FIG. 4 shows a schematic diagram of yet another embodiment of the present invention.

FIG. 5 shows a schematic diagram of yet another embodiment of the present invention.

FIG. 6 shows a schematic diagram of yet another embodiment of the present invention.

FIG. 7 shows a schematic diagram of yet another embodiment of the present invention.

FIG. 8 shows a schematic diagram of yet another embodiment of the present invention.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

“Business Process Management/Modeling” (“BPM”) means enterprise processes, including methods and systems, that promote and optimize business processes to achieve certain business objective (e.g., efficiency, effectiveness, flexibility, integration, etc.) For example, BPM can be a set of services and tools that provide for explicit BPM (e.g., process analysis, definition, execution, monitoring and administration), including support for human and application-level interaction. In another example, BPM supports design, execution and optimization of cross-functional business activities by both internal and external business users and technologists to incorporate people, application systems, and business partners. In yet another example, BPM can be composed of a sequence of activities (work tasks), interactions with human resources (users), or IT resources (software applications and data bases), as well as rules controlling the progression of processes through the various stages associated with its activities.

A BPM execution engine (workflow engine) is a software that is in charge of performing BPM processes.

“A business process” means a single and/or series or network of value-added activities, performed by their relevant roles or collaborators, to purposefully achieve the common business goal.

In some embodiments, BPM processes/applications can be designed for processing financial transactions. In some embodiments, BPM processes/applications can be designed for processing a credit application in which credit events (e.g., a change in credit rating, application for a credit card, or a default on a payment for example) would be monitored by a BPM server programmed by a business process diagram, and a BPM server would be used to determine how the business process would operate.

In some embodiments, BPM processes/applications can be designed for providing communication to a set of users as, for example, in a case where a set of secured mobile devices are being used by field personnel, and are managed by a centralized server. Broadcasting a message to such a set of users would require registering and scheduling a message with the centralized server. In some embodiments, mobile devices could be electronic devices such as thermostats which are capable of accepting commands or reprogramming operations remotely.

In some embodiments, BPM processes/applications can be designed for any business process that uses technology to perform at least one task.

### Illustrative Operating Environment

The invention may also be considered as a method of business process management including providing a network of computers and a business process control program so that a plurality of participants in a business process can interact with one another concerning the business process over the network, establishing a business process on the network made up of a plurality of tasks to be performed by the participants according to rules defined for the process, and providing a business process owner with means on the network to alter or add rules for processes that the business process owner owns.

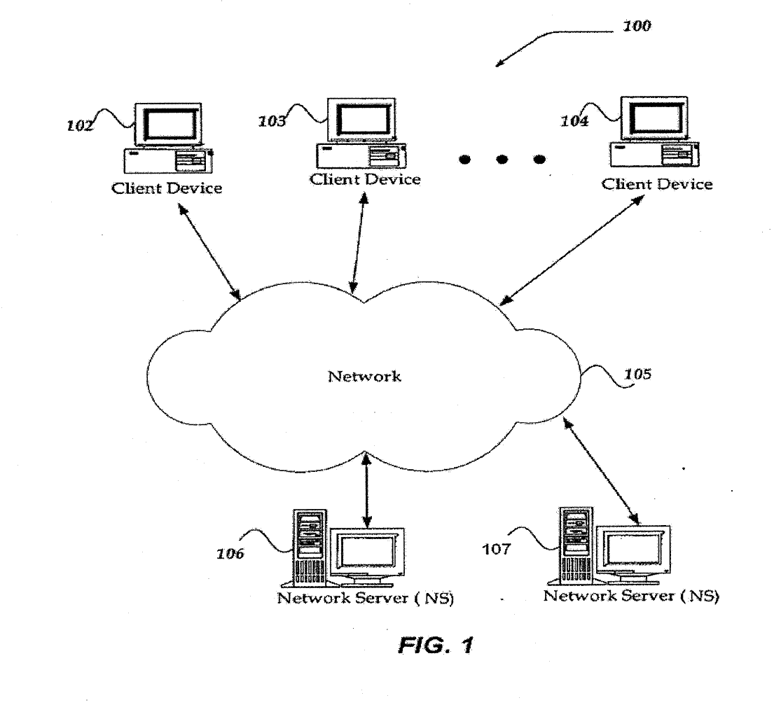

FIG. 1 illustrates one embodiment of an environment in which the present invention may operate. However, not all of these components may be required to practice the invention, and variations in the arrangement and type of the components may be made without departing from the spirit or scope of the invention. In some embodiment, the BPM inventive system hosts a large number of members and concurrent transactions. In other embodiments, the BPM inventive system computer is based on a scalable computer and network architecture that incorporates varies strategies for assessing the data, caching, searching, and database connection pooling.

In embodiments, members of the inventive computer system 102-104 (e.g. users of BPM for orchestration of activities) include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, electric distribution switches, SCADA controlled circuit breakers and transformers, electric generators (e.g. photovoltaic, wind, mobile generators, electric vehicles), Home Area Network (e.g. for management of appliance and energy usage in the home), wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like. In embodiments, the invention is programmed in either Javascript, Java or .Net.

In embodiments, member devices 102-104 may be further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

In embodiments, network 105 may be configured to couple one computing device to another computing device to enable them to communicate. In embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

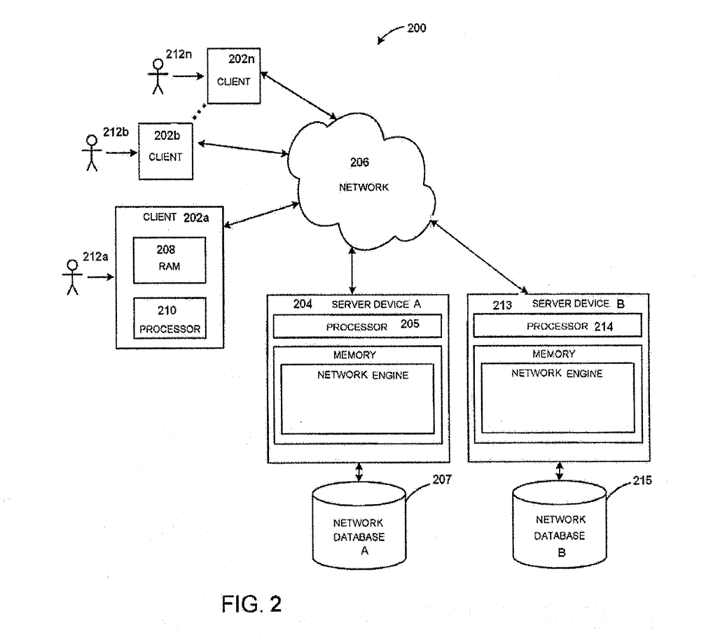

FIG. 2 shows another exemplary embodiment of the computer and network architecture that supports the inventive BPM system. The member devices 202a, 202b thru 202n shown (e.g. traders' desktops) each comprises a computer-readable medium, such as a random access memory (RAM) 208 coupled to a processor 210 or FLASH memory. The processor 210 may execute computer-executable program instructions stored in memory 208. Such processors comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, client devices 202a are any type of processor-based platform that is connected to a network 206 and that interacts with one or more application programs. Client devices 202a-n may operate on any operating system capable of supporting a browser or browser-enabled application, such as Microsoft™, Windows™, or Linux. The client devices 202a-n shown may include, for example, personal computers executing a browser application program such as Microsoft Corporation's Internet Explorer™, Apple Computer, Inc.'s Safari™, Mozilla Firefox, and Opera.

Through the client devices 202a-n, users (e.g., BPM customers and/or BPM .) 212a-n communicate over the network 206 with each other and with other systems and devices coupled to the network 206. As shown in FIG. 2, server devices 204 and 213 may be also coupled to the network 206.

In some embodiments, the instant invention can include a system that employs a Business Process Rules Management System (“BPRMS”) to control and manage demand response processes. In some embodiments, the inventive system can manage process can have a long life—i.e., long-term execution which means a process whose execution duration exceeds an average rate of occurrence of change of tasks that are related to the process-in-question.

In some embodiments, the instant invention can control and manage infrastructure-type processes that occur during periods between seconds to at most several days. In some embodiments, the instant invention can control and manage infrastructure-type processes that occur during periods of many months or years.

In some embodiments, the instant invention can utilize The Object Management Group's (“OMG”) the Unified Modeling Language (“UML”) compliant Business Process Model Notation (“BPMN”) standard, which represents a standard UML 2.0 requirements diagram. The disclosure, entitled “OMG Unified Modeling Language™ (OMG UML), Version 2.2” has been incorporated herein in its entirety by reference for all purposes, specifically to illustrate the notations and applications related UML. (Appendix A.) Appendix A is included for illustrative purpose to illustrate the incorporated disclosure, and the entire incorporated disclosure is not limited to its portion in Appendix A.

In some embodiments, for purposes of this disclosure, a modeling, or case, or use case BPM diagram is a computer code and /or associated design data that represents a process/system in terms of actors, their goals (can be represented as use cases), and any dependencies between those use cases. In some embodiments, the modeling, or case, or use case BPM diagram may have a graphical overview of the computer code and /or associated design data, for example, expressed in the UML format. Suitable modeling, or case, or use case BPM diagrams implementations include, but are not limited to, UML diagrams, computer-aided software engineering (CASE) diagrams, UML CASE diagrams, ER diagrams, Data flow diagram, Structure charts, Decision Trees, Decision tables, etc.

In some embodiments, for purposes of this disclosure, design data can include any process data (i.e., any data associated with a process-at-issue) associated with the process-at-issue for which the modeling, or case, or use case BPM diagram is to be designed. In some embodiments, the design data is continuously updated as new information about the designed process becomes available and/or pertinent. In some embodiments, updates to the design data can result in an evolution of the modeling, or case, or use case BPM diagram based on the modeling, or case, or use case BPM diagram's specifications and/or requirement. Suitable design data include, but are not limited to, actors involved, tasks, duration, requirements, rules (e.g., relationships between actors and/or tasks), etc.

In some embodiments, for purposes of this disclosure, a trigger condition means a condition/event whose occurrence (or non-occurrence) results in a performance of an activity in accordance with the modeling, or case, or use case BPM diagram for a process-in-question. For example, a particular condition of an air conditioning unit (e.g., loss of power, break down, overheating, etc.) can serve as a trigger condition based on specification(s) and requirement(s) of the modeling, or case, or use case BPM diagram for a DR process that monitors power curtailment among air conditioning units.

In some embodiments, for purposes of this disclosure, a normal condition means a condition/event whose occurrence (or non-occurrence) has been predicted and/or expected and thus is accounted for in the modeling, or case, or use case BPM diagram for a DR process-in-question.

In some embodiments, for purposes of this disclosure, an abnormal condition or means a condition/event whose occurrence (or non-occurrence) has not been predicted and/or expected and thus is not accounted for in the modeling, or case, or use case BPM diagram for a DR process-in-question.

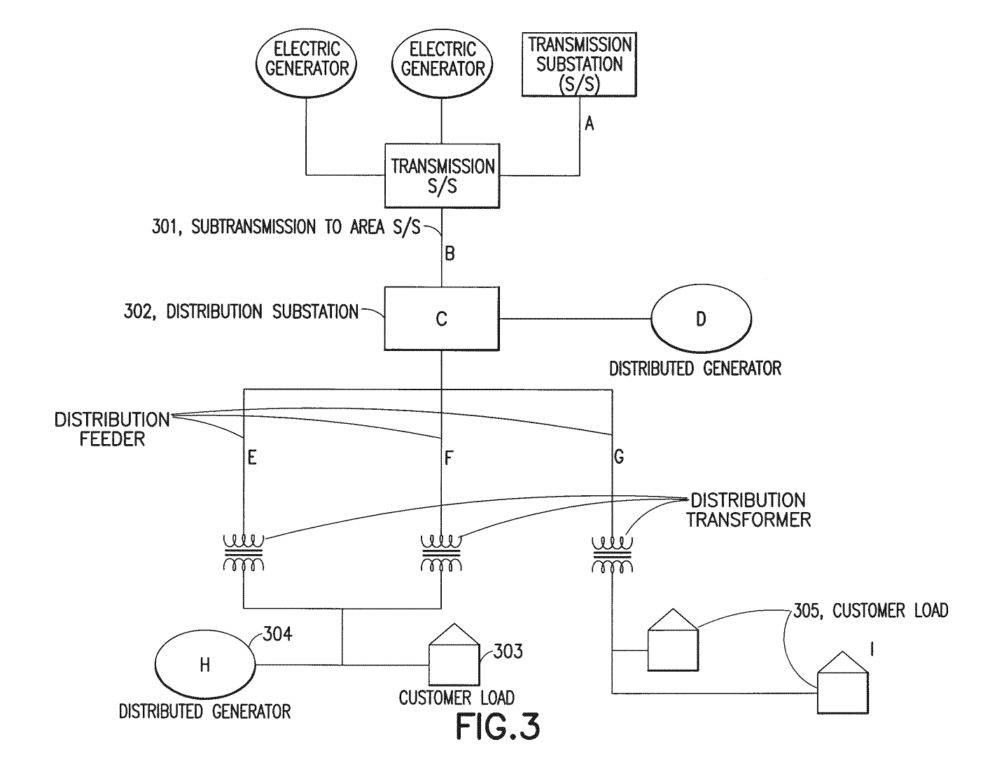

Referring to FIG. 3 which shows a schematic representation for application of some embodiments of the present invention to an infrastructure for delivering electrical power. In some embodiments, the instant invention allows to decide on what responses to take during an emergency (can be normal or abnormal condition) while processes and rules associated with different curtailment actions are continuously changing. For example, in some embodiments, the instant invention allows Demand Response (“DR”) programs of public utilities to continue to evolve as DR programs are refined and/or approved/modified by the Public Service Commission.

In some embodiments, the instant invention allows DR programs to provide options to aggregators and loads based on a choice of actions to which customers are willing to contractually obligate themselves. In some embodiments, the instant invention allows, without additional computer programming, to change DR contracts and actions for various responses and/or modify the distribution system on-the-fly depending on the options made available. In some embodiments, the instant invention allows new BPM-based DR programs and systems to co-exist and/or assimilate existing contracts, programs, and systems. In some embodiments, by using BPM, the instant invention allows control center operators and/or DR program administrators to have a unified capability, with the inventive system handling the details of how to orchestrate multiple and differing curtailment processes, load types, emergency incidents, vulnerabilities in electric service, and/or contractual situations.

In some embodiments, the instant invention allows for a capability to initiate and coordinate concentrated efforts in order to influence the area of concern. In some embodiments, the instant invention provides for an interface and automated workflow-management capabilities to involve the use of field crews in curtailment processes, when it is necessary, and/to coordinate human activities with electronic actions. For example, in some embodiments, the instant invention can suggest and orchestrate field crew response to communicate with a customer at his premise to reduce load in the specific location affected by an incident based on the customer's past use of electricity, forecasted usage, type of customer (i.e., normal, predicted conditions) (e.g. electrolyzing facility, bakery, freezer storage), the past history of similar request to this customer, customer's location in relation to other high value customers, and predicted availability of the customer rather than employing less targeted “shot gun” approaches of just sending out a command to have crews go to any customer premises and request load curtailment. For example, in some embodiments, the instant invention can suggest and orchestrate field crew response to specific locations based on the incident to physically connect up generators or remove connected loads (e.g. a mobile dispatch of an emergency generator (304) or to physically disconnect electric vehicles from electric vehicle chargers).

In some embodiments, the instant invention allows DR programs to use smart devices (e.g., meters that are able to communicate their state remotely and/or perform certain instructed actions) to continuously capture, store, verify, and/or store (history) data to reliably curtail loads based on capacity, energy pricing, and/or emergency signals. In some embodiments, the instant invention uses the stored data to continually assess the vulnerability of an electrical system to an incident given modularity in load and/or other operator actions, and, if the vulnerability arises, the instant invention would allow a BPM-based DR program to stop a situation and take action to mitigate any perceived risk accordingly.

In some embodiments, “what if” simulations can be performed for detection of vulnerabilities that if certain equipment were to fail when an infrastructure would be overstressed beyond its design basis (e.g. simulations of all possible failures to determine whether deterministic reliability criteria have been met.) For example, the simulations can involve tests for situations when 1st contingency design is violated (a trigger condition) resulting in equipment overloaded with the flow of electric power because load can not be curtailed (abnormal condition). In some embodiments of the instant invention, “what if” simulations of BPM orchestration of actions would take into consideration various constraints such as load available to curtail (e.g. contractual obligations, physical locations of load not available in the needed area), no connection points for mobile generation, procedural rules, and time constraints in achieving load curtailment.

In some embodiments of the instant invention, the management of such “what if” simulations is performed using BPM based on events such as SCADA (supervisory control and data acquisition) anomaly alarms or requests for scheduled outages or as a sequential step in a process to meet a procedure requiring such simulation upon an event.

In some embodiments, the instant invention can involve using BPM to manage one or more subsystems of a typical SCADA system which typically represents a computer system that monitors and controls industrial, infrastructure, or facility-based processes. The typical SCADA system usually include:

a) a Human-Machine Interface or HMI is the apparatus which presents process data to a human operator, and through this, the human operator monitors and controls the process;

b) a supervisory (computer) system, gathering (acquiring) data on the process and sending commands (control) to the process;

c) Remote Terminal Units (RTUs) connecting to sensors in the process, converting sensor signals to digital data and sending digital data to the supervisory system;

d) Programmable Logic Controller (PLCs) used as field devices or within facilities, because they are more economical, versatile, flexible, and configurable than special-purpose RTUs; and/or

e) Communication infrastructure connecting the supervisory system to the Remote Terminal Units.

In some embodiments, the instant invention can detect vulnerabilities (i.e., abnormal condition(s), or (anomalies)) from predicted violations (i.e., normal or expected conditions) under situations if certain equipment were to fail, resulting in an overstressed system. In some embodiments, the instant invention can apply a BPM to orchestrate various algorithmic simulations of potential states of the system upon changes in equipment status (e.g., upon a breaker opening in the system located at the distribution substation (302) a simulation is orchestrated by the inventive system that might show that if a subtransmission feeder (301) fails to supply power to a distribution substation (302) (i.e., a specific trigger condition) some electric system equipment at the distribution substation (302) would be above its design basis, resulting in the BPM initiating tasks such as a pre-incident planning and/or preemptive activities planning. In some embodiments, the instant invention can allow a user to define characteristics of the pre-incident to which the inventive system would then respond using the defined demand response BPM.

In some embodiments, the instant invention can allow a user to perform and/or recommend sequential and/or non-sequential activities (business processes) within a defined case management framework of the demand response management system to investigate and conclude detected pre-incident is valid and/or of concern. In some embodiments of the instant invention, if the pre-incident concern is valid, the inventive system allows a response manager to prescribe a collection of suggested or recommended activities or business processes for this pre-incident to modify the initial BPM ((i.e., normal conditions, such as pre-positioning of crews and equipment to be available to quickly switch load demand to another part of the electric system, dispatch of mobile generation to specific locations to reduce demand on the system if the failure were to occur).

In some embodiments, the instant invention provides for an initial BPM that can contain a set of rules (such as company mandated procedures of notification upon exposure levels), connectivity traces of energy assets, and/or customer load effected or having the potential to effect the case if the incident were to actually occur.

In some embodiments, the instant invention can allow a user to program activities (business processes) that are prescribed for pre-emptive mitigation of risk of exceeding design parameters (e.g., overloading of electric equipment at the distribution substation (302)). In some embodiments, the instant invention can then allow the user to adapt the programmed business process models, based on the user's knowledge within a case management framework for the above specific pre-incident, to pre-emptively enable a potential modification of BPM-controlled demand response for a power distribution in an electric grid. In some embodiments, the instant invention can then allow the user to pre-set business processes in place that if the incident were to actually occur, an agreed immediate action could take place automatically and in quick fashion in accordance with the modified BPM.

In some embodiments, the instant invention can rank a list of prescriptive solutions to mitigate exposure to the pre-incident prior to the incident happening. For example, in some embodiments, the instant invention might suggest to initiate BPM to orchestrate the logistical delivery and connection of an emergency mobile generator to the distribution substation as the highest ranked prescribed activity to prepare for a specific potential incident (i.e., normal condition), but not turn it on unless the incident occurred. In some embodiments, ranking can be based on cost of a workflow, benefits from performing the workflow, cost of the incident if it were to happen with a multiplier based on the probability of the event happening, availability of crews or other maintenance related assets, and/or mission risk for a specified activity.

In some embodiments, the instant invention can provide for a business process of notification to various demand response program participants and/or feedback in a form of acknowledgement to meet contractual obligations of being notified, inter alia, four hours in advance of the actual demand response event.

In some embodiments, in response to the pre-incident BPM testing, the instant invention can provide suggestion(s) of business processes to change crew availability to be prepared in case such an event were to take place or to cancel a scheduled workflow to take another piece of equipment out of service for maintenance.

In some embodiments, the instant invention can provide for BPM to take into account existing incidents, for example, at customer's service point. In some embodiments, the user's BPM can determine if existing real time identified incidents should be classified as potential of having root cause effects to, or from, a previously or post identified pre-incident else where associated with the electric system.

In some embodiments, depending on findings and user adaption (e.g., based on the user's knowledge), the instant invention allows to link various separate incidents, which are initially part of separate and/or different response management cases (e.g., one incident being, for example, an actual on-going real event, and another incident being, for example, a vulnerability pre-incident with its own specific case). In some embodiments, the linking could be based on a connectivity of energy assets. For example, an incident at a customer load (303) of real-time low voltage may be resolved by initiating an emergency generator H (304), which would also impact positively a vulnerability incident at the subtransmission location (301) detected by a simulation. In some embodiments, the linking incidents or cases within a response manager BPM case could be based on geographic location interdependency and/or organization interdependency. In some embodiments, the linking may have hierarchy of response management cases that require approvals to proceed with one case while having a potential impact on another response manager case.

In some embodiments, if an incident detected during a simulation where to actually occur in the system, illustrated in FIG. 3, or just happened to occur with no pre-warning, the instant invention can allow a response manager to become an active manager of workflow via an adapted BPM and non-sequential tasks to contain the incident by reducing demand affecting the affected part of the power distribution system of FIG. 3 and arranging processes to restore the power distribution system to a normal state through containment and restoration efforts.

In some embodiments, the instant invention allows to use BPM for managing demand response in the power distribution system of FIG. 3 that can come in the form of curtailment of load and/or changing a state. In some embodiments, the instant invention allows to use BPM in conjunction with a specific algorithmic analysis such as simulations of power flow for measuring potential limits of reliability criteria.

In some embodiments, the instant invention allows to use BPM to manage pre-incident activities to preemptively mitigate exposure of risk from a demand that exceeds equipment design characteristics (i.e., abnormal conditions).

In some embodiments, BPMs of the instant invention can have an adaptive capability which allows BPMs to evolve even after they have been activate and/or completed earlier tasks.

In some embodiments, the instant invention provides for the adaptive capability of adding or modifying business processes and activities within a BPM case management framework to change demand on a system based on a set of rules.

In some embodiments, the instant invention provides for a capability of record keeping of actions (history) taken by a user to correct activities suggested by a BPM's simulation.

In some embodiments, the instant invention provides for a learning engine which is programmed to store and extract data from experience of past activities to provide optimal and preferred BPM for a similar type of incident (e.g., user preferences of initiated activities for specific types of events, past suggestions in similar cases). In some embodiments, the instant invention provides for a standardization of BPM demand response cases.

In some embodiments, the instant invention provides for functionalities to track, measure, and/or analyze workflow (BPMs) through demand response management cases (e.g., incidents, simulations, etc.).

In some embodiments, the instant invention provides for a capability of providing case templates of business processes and activities for specific types of incidents. In some embodiments, the provided templates can be modified by a user prior to or during initiation of such activities.

In some embodiments, the instant invention can provides the capability of suggesting a cause and effect linking of various incidents based on interdependency of incidents due to relationships such as connectivity of assets, geographic location between assets, and/or organization structure of workforce and machinery.

In some embodiments, the instant invention provides a capability of notifying stakeholders based on a set of rules upon the discovered pre-incident or incident.

In some embodiments, the instant invention can allow a particular user to browse all cases and linking made by other user(s) and/or suggested by the inventive system itself.

In some embodiments of the instant invention, an exemplary BPM-implemented DR program can include an interactive interface showing the DR processes using Business Process Modeling Notation (BPMN). In some embodiments of the instant invention, an interactive interface is provided to a user who can manipulate DR's events/activities by changing a BPM diagram through the interactive interface using elements of BPMN.

In some embodiments of the instant invention, an exemplary BPM-implemented DR program can include an interactive interface of the DR processes using a simple list of sequential tasks with indication of whether the task has been performed already, has been skipped, is in process or communication or action, and in some cases indicating the expected and actual times at which such BPM tasks will be, or were, performed.

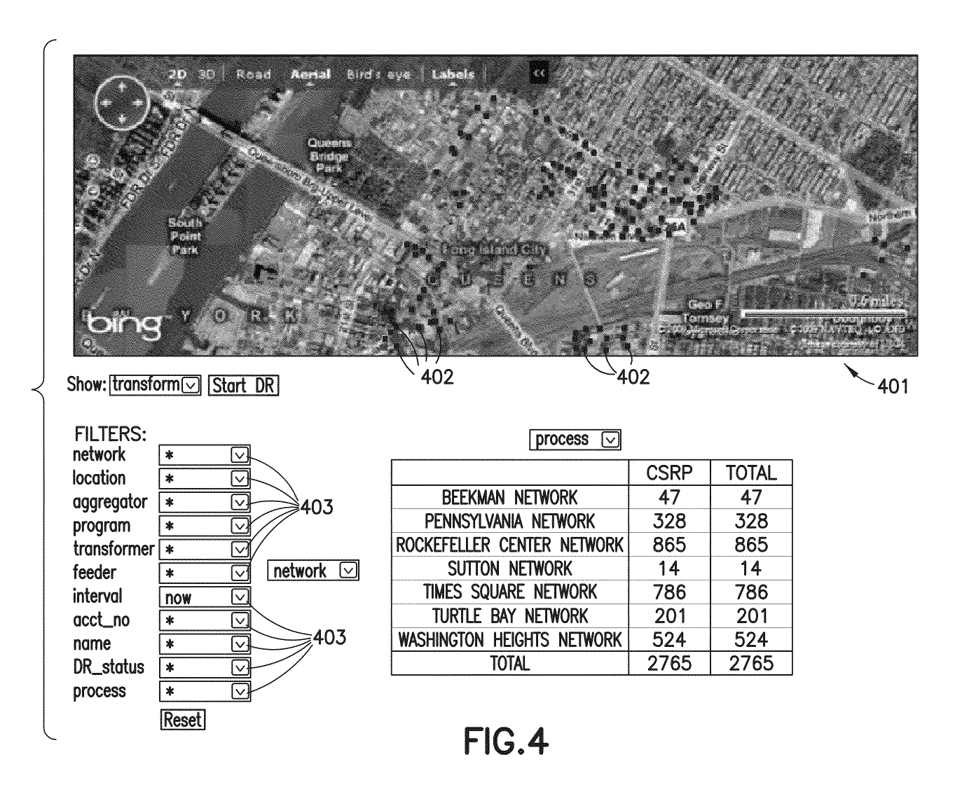

FIG. 4 shows a computer interface for some embodiments of the instant invention. In some embodiments, the computer interface of FIG. 4 can be used to manage emergency curtailment in a BPM-based DR program of the instant invention. FIG. 4 shows a portion of a map of geographic locale (401), identifying air conditioning units (402) whose operation/electricity feed can be controlled by the BPM-based DR program of the instant invention. In some embodiments, the inventive interface of FIG. 4 can further include drill-down controls which can allow to specifically curtailing load where it is needed based on parameters/filters (403).

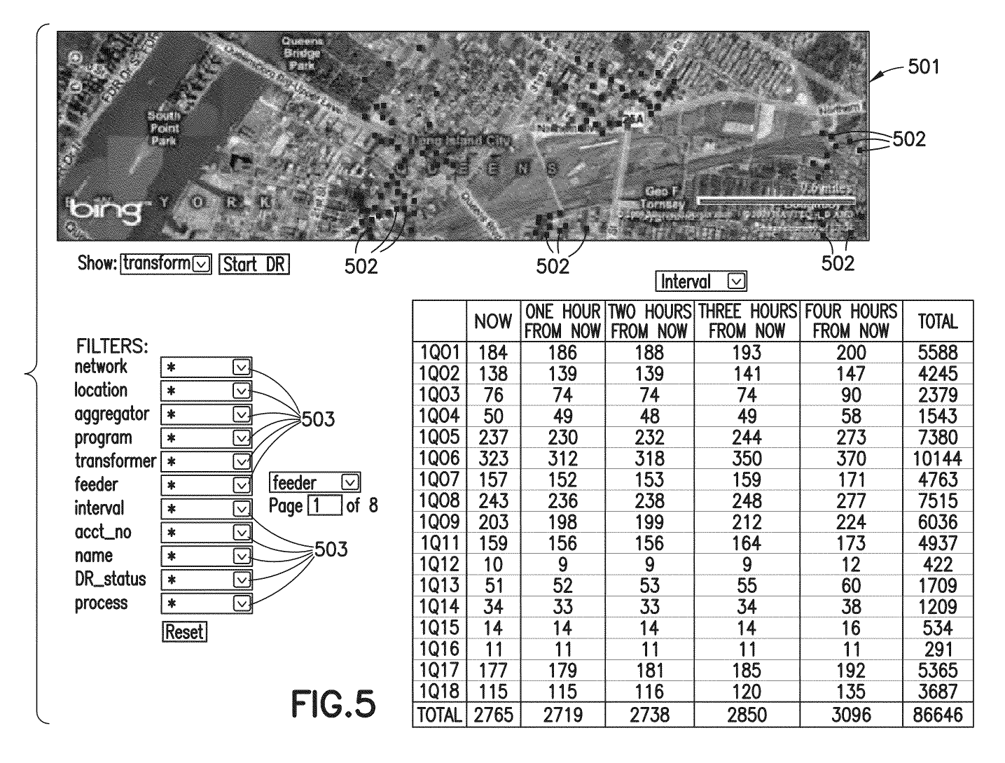

FIG. 5 shows a computer interface for some embodiments of the instant invention. In some embodiments, the computer interface of FIG. 5 can be used to manage emergency curtailment in a BPM-based DR program of the instant invention. FIG. 5 shows a portion of a map of geographic locale (501), identifying air conditioning units (502) whose operation/electricity feed can be controlled by the BPM-based DR program of the instant invention. In some embodiments, the inventive interface of FIG. 5 can further include drill-down controls which can allow to specifically curtailing load where it is needed based on parameters/filters (503). In some embodiments, the inventive interface of FIG. 5 can further summarizes DR footprint by transformer, DR program, or feeder to enable BPM-based DR operators to understand the relief/curtail that the operators can count on for a specific condition from a timed perspective.

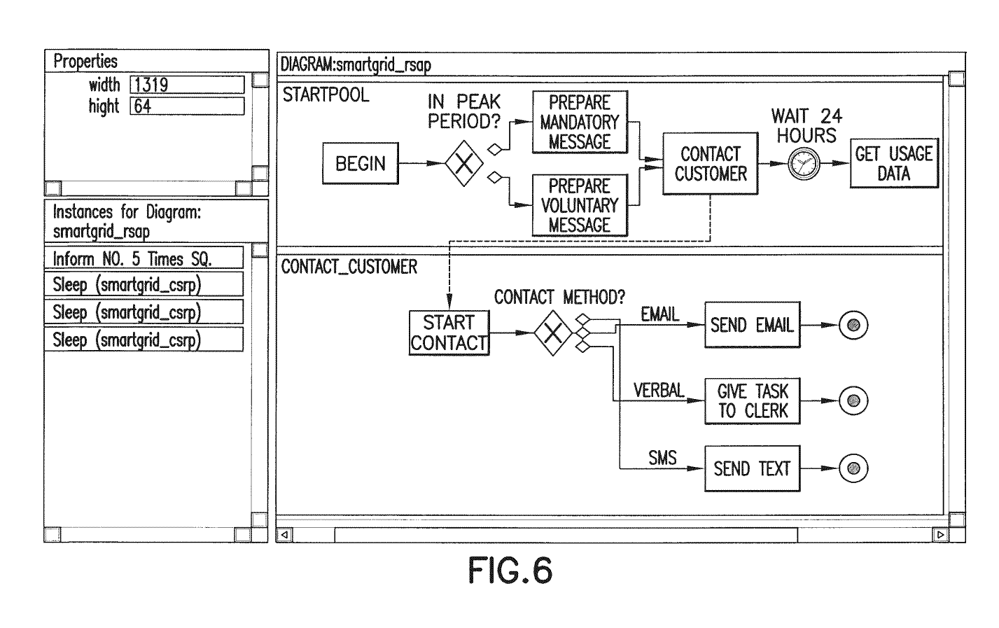

FIG. 6 shows a computer interface for some embodiments of the instant invention. In some embodiments, the computer interface of FIG. 6 illustrates how the instant BPM-based inventive system can manage DR processes and/or an electrical grid operator's actions to respond to conditions of the grid.

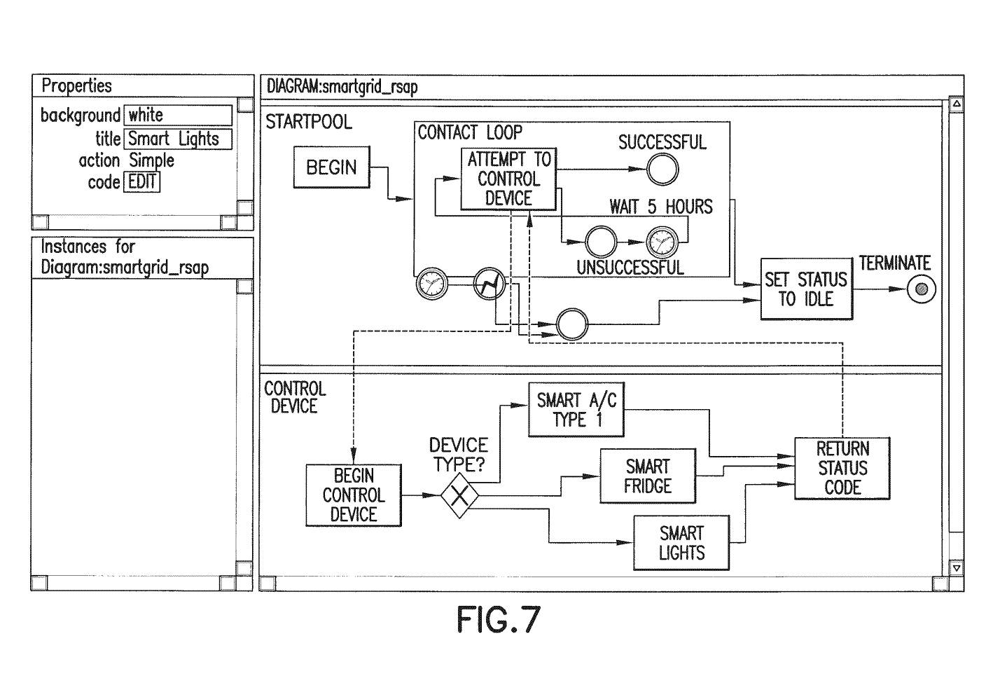

FIG. 7 shows a computer interface for some embodiments of the instant invention. In some embodiments, the computer interface of FIG. 7 illustrates how the instant BPM-based inventive system can manage communication methods based on a preferred choice of an aggregator, electric vehicle charge, and/or load controller in the field.

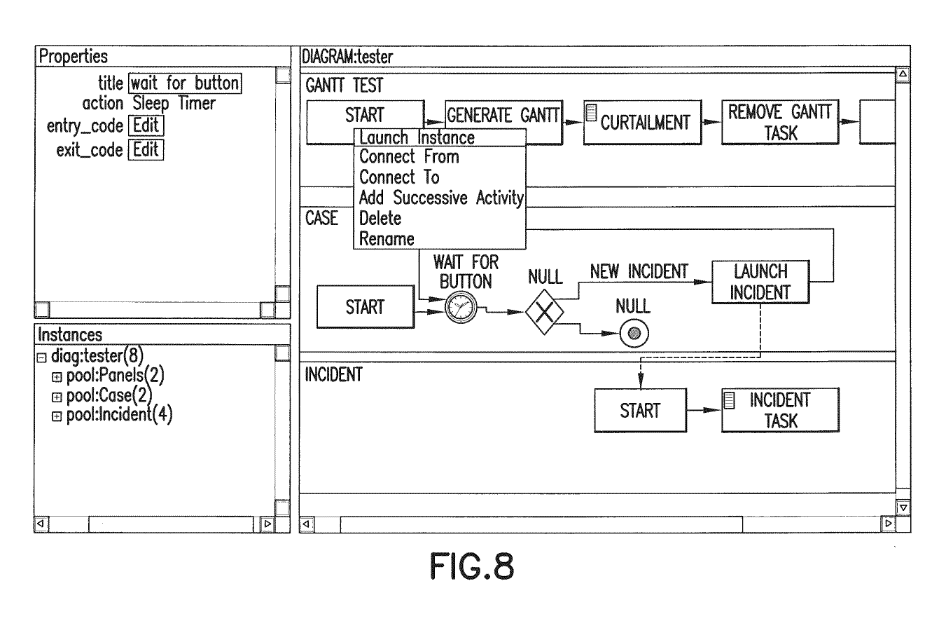

FIG. 8 shows a computer interface for some embodiments of the instant invention. In some embodiments, the computer interface of FIG. 8 illustrates how the instant BPM-based inventive system can manage incidents for a particular BPM case. For some embodiments, a BPM case is an instance of a business process proceeding in accordance with a BPM diagram. For example, in a case electrical utility, in some embodiments, if a BPM diagram represents a business process of opening a customer account, then each BPM case is a separate process of account opening for a particular customer.

In some embodiments, the instant invention involves a method for managing at least one demand response process which includes at least the steps of: providing, by a computer system, an interface having a plurality of programmable elements, wherein each programmable element can be associated with a particular action to be performed during the at least one demand response process when a particular programmable element is programmed and incorporated into at least one business process modeling diagram associated with the at least one demand response process, and wherein the at least one demand response process is initiated in response to at least one trigger condition of at least one first enterprise process; receiving, by a computer system, first design data corresponding to the at least one business process modeling diagram; monitoring, by a computer system, the at least one first enterprise process for a presence of the at least one trigger condition by performing at least one of the following: i) receiving process data associated with the at least one first enterprise process, and ii) subjecting at least one process element of the at least one first enterprise process to at least one: a) normal operating condition, and b) abnormal operating condition; and executing, by a computer system, the at least one demand response process in accordance with the at least one business process modeling diagram when the at least one trigger condition is present.

In some embodiments, the instant invention involves a method that includes a step of receiving second design data wherein the second design data corresponds to at least one change in the at least one business process modeling diagram.

In some embodiments, the instant invention involves a method that includes at least one change that is based on process data of at least one second enterprise process.

In some embodiments, the instant invention involves a method that includes a step of generating at least one notification based on at least one rule.

In some embodiments, the instant invention involves a method that includes at least one rule is associated with the presence of at least one trigger condition.

In some embodiments, the instant invention involves a computer system for managing at least one demand response process which includes a) memory having at least one region for storing computer executable program code; and b) a processor for executing the program code stored in the memory, wherein the program code that includes: i) code to provide an interface having a plurality of programmable elements, wherein each programmable element can be associated with a particular action to be performed during the at least one demand response process when a particular programmable element is programmed and incorporated into at least one business process modeling diagram associated with the at least one demand response process, and wherein the at least one demand response process is initiated in response to at least one trigger condition of at least one first enterprise process; ii) code to receive first design data corresponding to the at least one business process modeling diagram; iii) code to monitor the at least one first enterprise process for a presence of the at least one trigger condition by performing at least one of the following: 1) receiving process data associated with the at least one first enterprise process, and 2) subjecting at least one process element of the at least one first enterprise process to at least one: A) normal operating condition, and B) abnormal operating condition; and iv) code to execute the at least one demand response process in accordance with the at least one business process modeling diagram when the at least one trigger condition is present.

While a number of embodiments of the present invention have been described, it is understood that these embodiments are illustrative only, and not restrictive, and that many modifications may become apparent to those of ordinary skill in the art. For example, certain methods may be “computer implementable” or “computer implemented.” In this regard, it is noted that while such methods can be implemented using a computer; the methods do not necessarily have to be implemented using a computer. Also, to the extent that such methods are implemented using a computer, not every step must necessarily be implemented using a computer. Further, any steps described herein may be carried out in any desired order (and any steps may be added and/or deleted).

What is claimed is:

1. A method for managing at least one demand response process, comprising:
providing, by a computer system, an interface having a plurality of programmable elements, wherein each programmable element can be associated with a particular action to be performed during the at least one demand response process when a particular programmable element is programmed and incorporated into at least one business process modeling diagram associated with the at least one demand response process, and wherein the at least one demand response process is initiated in response to at least one trigger condition of at least one first enterprise process;
receiving, by a computer system, first design data corresponding to the at least one business process modeling diagram;
monitoring, by a computer system, the at least one first enterprise process for a presence of the at least one trigger condition by performing at least one of the following:
i) receiving process data associated with the at least one first enterprise process, and
ii) subjecting at least one process element of the at least one first enterprise process to at least one:
a) normal operating condition, and
b) abnormal operating condition; and
executing, by a computer system, the at least one demand response process in accordance with the at least one business process modeling diagram when the at least one trigger condition is present.

2. The method of claim 1, further comprising, prior to the executing step, a step of receiving second design data wherein the second design data corresponds to at least one change in the at least one business process modeling diagram.

3. The method of claim 2, wherein the at least one change is based on process data of at least one second enterprise process.

4. The method of claim 1, further comprising, prior to the executing step, a step of generating at least one notification based on at least one rule.

5. The method of claim 4, wherein the at least one rule is associated with the presence of the at least one trigger condition.

6. A computer system for managing at least one demand response process, comprising:
a) memory having at least one region for storing computer executable program code; and
b) a processor for executing the program code stored in the memory, wherein the program code comprising:
i) code to provide an interface having a plurality of programmable elements, wherein each programmable element can be associated with a particular action to be performed during the at least one demand response process when a particular programmable element is programmed and incorporated into at least one business process modeling diagram associated with the at least one demand response process, and wherein the at least one demand response process is initiated in response to at least one trigger condition of at least one first enterprise process;
ii) code to receive first design data corresponding to the at least one business process modeling diagram;
iii) code to monitor the at least one first enterprise process for a presence of the at least one trigger condition by performing at least one of the following:
1) receiving process data associated with the at least one first enterprise process, and
2) subjecting at least one process element of the at least one first enterprise process to at least one:
A) normal operating condition, and
B) abnormal operating condition; and
iv) code to execute the at least one demand response process in accordance with the at least one business process modeling diagram when the at least one trigger condition is present.

7. The computer system of claim 6, further comprising, code to receive second design data wherein the second design data corresponds to at least one change in the at least one business process modeling diagram.

8. The computer system of claim 7, wherein the at least one change is based on process data of at least one second enterprise process.

9. The computer system of claim 6, further comprising, code to generate at least one notification based on at least one rule.

10. The computer system of claim 9, wherein the at least one rule is associated with the presence of the at least one trigger condition.
